(19) United States
(12) Patent Application Publication
(10) Pub. No.: US 2011/0116926 A1
(43) Pub. Date: May 19, 2011

(54) Self-Directing Vertical Axis Turbine For Harnessing Power

(76) Inventors: Donald A. Fox, Arma, KS (US); Ryan Kraft, Frot Scott, KS (US)

(21) Appl. No.: 13/014,573

(22) Filed: Jan. 26, 2011

Related U.S. Application Data
(63) Continuation-in-part of application No. PCT/US2009/068649, filed on Dec. 18, 2009.
(60) Provisional application No. 61/138,547, filed on Dec. 18, 2008.
(60) Provisional application No. 61/177,157, filed on May 11, 2009.

(51) Int. Cl. F03D 7/02

(52) U.S. Cl. 416/13

(57) ABSTRACT

A self-directing vertical axis turbine includes a base, a primary hub rotatably coupled to the base for rotation about a first axis, primary support arms extending from the primary hub, a positioning arm rotatably coupled to the base for free rotation about the first axis, a secondary hub rotatably coupled to the positioning arm for rotation about a second axis that is spaced apart from and generally parallel to the first axis, secondary arms extending outwardly from the second hub, and capturing elements. Each capturing element is rotatably coupled to respective primary and secondary arms. The positioning arm and the primary hub are independently attached to the base to allow rotation about the base at different times and speeds. The positioning arm rotates based upon forces imparted by a fluid upon the capturing elements and transferred to the positioning arm by the secondary arms and the secondary hub.

### RELATED APPLICATIONS

This application is a continuation-in-part of PCT Application No. PCT/US2009/068649, filed Dec. 18, 2009, which in turn claims the benefit of priority to U.S. provisional application 61/138,547, filed Dec. 18, 2008, and to U.S. provisional application 61/177,157, filed May 11, 2009, the contents of all of which are incorporated herein by reference.

### BACKGROUND

The invention relates generally to the field of power generation. More particularly, the invention relates to the field of turbines used to harness power.

Systems for capturing power from moving air and water have been used for centuries. Wind turbines which generate electrical power typically include a propeller mechanism, a generator, and a device for storing/transporting the generated electrical energy. Because wind direction often shifts (and sometimes quite suddenly), wind turbines that are not capable of being re-directed are generally inefficient. Accordingly, many modern wind turbines additionally include devices that re-direct the propeller mechanism in accordance with shifts in wind direction.

One example of a device that re-directs a propeller mechanism in accordance with shifts in wind direction is found in U.S. Pat. No. 6,069,409 to Fowler. There, a wind vane and a propeller mechanism are attached to a rotatable support, and the wind vane interacts with the wind to re-position the propeller mechanism. Another example is found in JP 2008-202499, where anemometers and servo motors are used to adjust a propeller mechanism in accordance with shifts in wind direction.

A turbine that automatically self-directs without the use of a wind vane or electrical sensors in communication with actuating equipment (e.g., a motor, gearing, etc.) has been conspicuously absent.

### SUMMARY

According to one embodiment, a self-directing vertical axis turbine includes a base, a first hub, a plurality of first support arms, a positioning arm, a second hub, a plurality of second support arms, and a plurality of capturing elements. The first hub is rotatably coupled to the base for free rotation about a first generally vertical axis. The first support arms extend radially from the first hub, and each first support arm has a distal end. The positioning arm is rotatably coupled to the base for free rotation about the first generally vertical axis. Attachment of the positioning arm to the base is independent of the attachment of the first hub to the base, such that the positioning arm and the first hub may rotate about the base at different times and speeds. The second hub is rotatably coupled to a distal end of the positioning arm for rotation about a second generally vertical axis. The plurality of second support arms extend outwardly from the second hub, and each second support arm has a distal end. Each capturing element is rotatably coupled to a respective first arm distal end and a respective second arm distal end. The first support arm distal ends have a common path of travel about the base that circumscribes a first circle having a constant diameter and a constant location relative to the base. The second support arm distal ends have a common path of travel about the second hub that circumscribes a second circle; the location of the second circle relative to the base moves with rotation of the positioning arm relative to the base. The first and second circles having center points that are offset from one another. The positioning arm rotates about the first axis based upon forces imparted by a fluid upon the capturing elements and transferred to the positioning arm by the second support arms and the second hub.

In another embodiment, a self-directing vertical axis turbine includes a base, a primary hub rotatably coupled to the base for rotation about a first axis, a plurality of primary support arms, a positioning arm rotatably coupled to the base for free rotation about the first axis, a secondary hub, a plurality of secondary arms, and a plurality of capturing elements. The primary support arms extend radially from the primary hub, and each primary support arm has a distal end. The secondary arms extend outwardly from the second hub, and each secondary arm has a distal end. Attachment of the positioning arm to the base is independent of the attachment of the primary hub to the base, such that the positioning arm and the primary hub may rotate about the base at different times and speeds. The secondary hub is rotatably coupled to the positioning arm for rotation about a second axis that is spaced apart from and generally parallel to the first axis. The second axis is fixed relative to the positioning arm and is movable relative to the first axis. Each capturing element is rotatably coupled to a respective primary support arm distal end at a first point and a respective secondary arm distal end at a second point. The first points have a common path of travel about the base that circumscribes a first circle having a constant diameter and a constant location relative to the base. The second points have a common path of travel about the second hub that circumscribes a second circle. The location of the second circle relative to the base moves with rotation of the positioning arm relative to the base, and the first and second circles having center points that are offset from one another. The positioning arm rotates about the first axis based upon forces imparted by a fluid upon the capturing elements and transferred to the positioning arm by the secondary arms and the secondary hub.

### BRIEF DESCRIPTION OF THE DRAWINGS

FIG. 1 is an isometric view of a self-directing vertical axis turbine according to one embodiment of the present invention, with two capturing elements shown in broken lines for illustration;

FIG. 2 is a top view of the self-directing vertical axis turbine of FIG. 1, with wind direction indicated;

FIG. 3 is a cross-sectional view taken along line 3-3 of FIG. 2;

FIGS. 4-7 are top views of the self-directing vertical axis turbine of FIG. 1 in use with winds from various directions;

FIG. 8 is a top view of the self-directing vertical axis turbine of FIG. 1, showing select paths of travel; and

FIG. 9 is an isometric view of a self-directing vertical axis turbine according to another embodiment of the present invention, with two capturing elements shown in broken lines for illustration.

### DETAILED DESCRIPTION

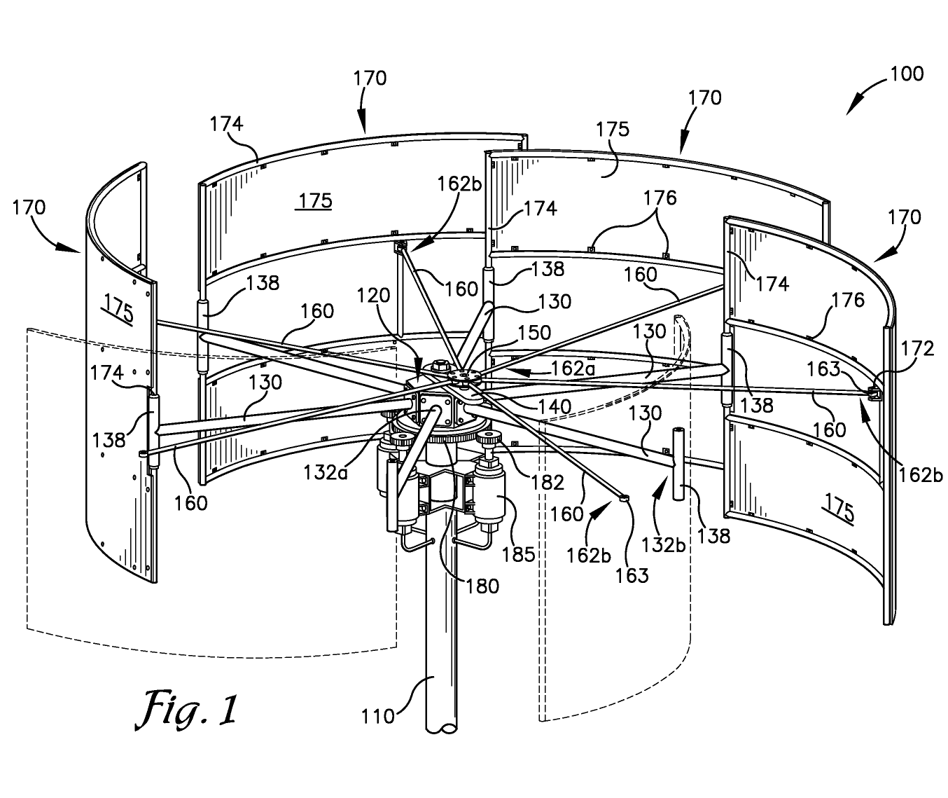

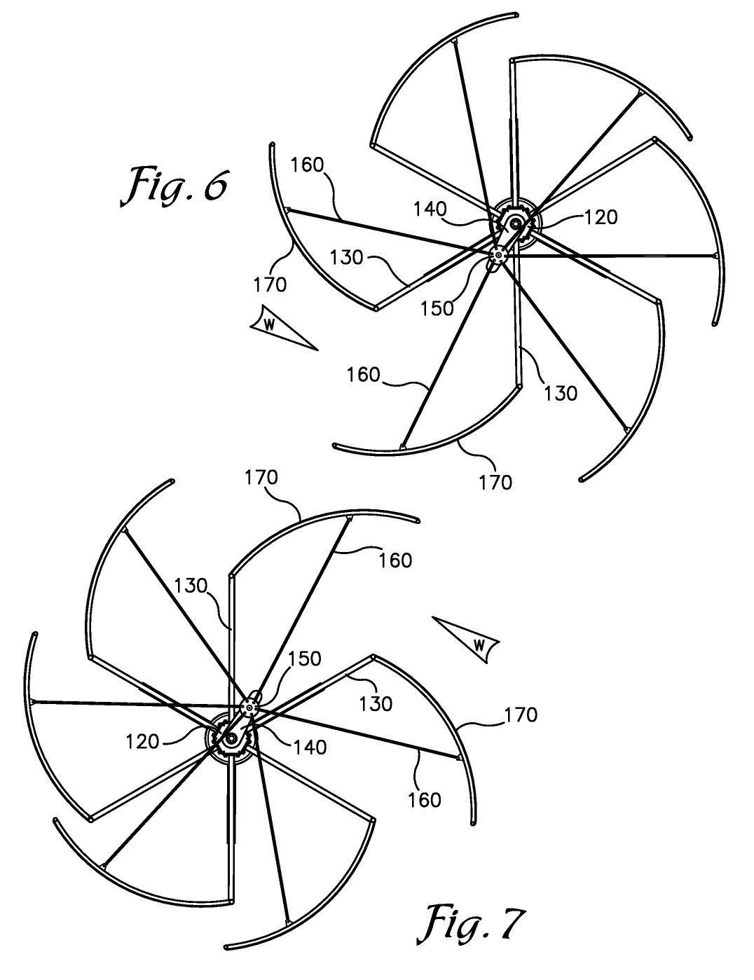

Detailed descriptions of various embodiments are set forth herein, with reference to the accompanying drawings, to enable those skilled in the art to practice the current invention. FIGS. 1 through 8 show a self-directing vertical axis turbine 100 according to one embodiment of the present invention. The turbine 100 has a stationary base 110, a primary hub 120, primary support arms 130, a self-positioning arm 140, a secondary hub 150, secondary (or “adjustment”) arms 160, and capturing elements 170. Though the turbine 100 is generally described herein for use in capturing wind, those skilled in the art will appreciate that the turbine 100 may alternately be used with other moving fluids, such as ocean currents, and that the turbine 100 may be particularly well suited for use with moving fluids (e.g., wind, currents, etc.) that change direction.

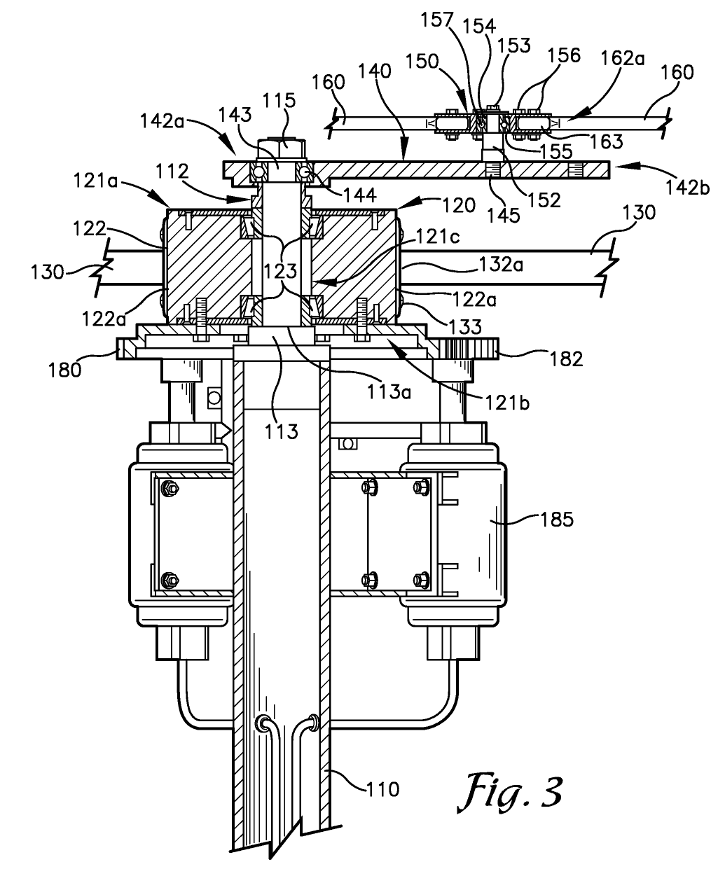

The stationary base 110 shown in the accompanying figures (FIGS. 1 and 3) is a pole that extends generally vertically (i.e., generally perpendicularly to horizontal). The entire base 110 may extend generally vertically (as shown), or a terminal portion 112 (FIG. 3) may extend generally vertically such that the primary hub 120 rotates about a generally vertical axis. While the terminal portion 112 is shown to be segmented in FIG. 3, with different portions having different diameters, the terminal portion 112 may alternately have a constant diameter or collars may provide ledges about a generally constant diameter. The stationary base 110 may be constructed of any appropriate material, with particular consideration being given to the forces imparted by the movement of the other elements of the turbine 100. For example, the stationary base 110 may be constructed of metal and/or reinforced concrete; metal pipe is shown in FIG. 3. While the term “stationary base” is used herein, those skilled in the art will appreciate that the base 110 may in fact move, but that such movement typically does not add to the direct operation of the turbine 100. For example, the stationary base 110 may be pivotable (e.g., by hydraulics) to allow the terminal portion 112 to be closer to a ground surface for repairing or refurbishing the turbine 100.

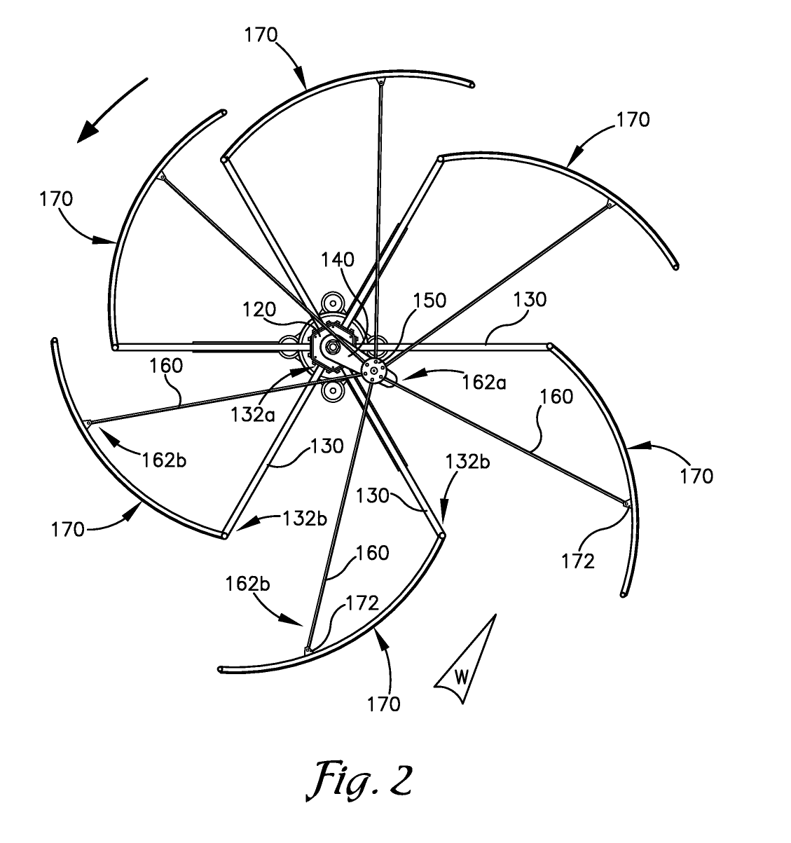

As shown in FIG. 3, the primary hub 120 has upper and lower ends 121a, 121b, a hollow central area 121c, and an outer surface 122. In the turbine 100, the outer surface 122 includes six faces 122a offset from one another such that that a perimeter of the hub 120 appears to be a hexagon in a cross-sectional or top view (FIG. 2). The number of faces 122a may correspond to the number of capturing elements 170. Alternate configurations may be used for the hub 120, so long as the hub 120 is rotatable about the stationary base 110 and provides attachment points and support for the primary support arms 130, as discussed further below.

The primary hub 120 is mounted to the stationary base 110 in a manner that allows the primary hub 120 to rotate about a generally vertical axis, preferably with little resistance from interaction with the base 110. As shown in FIG. 3, the base 110 passes through the hollow central area 121c of the hub 120. Bearings 123 may be particularly helpful in minimizing friction between the primary hub 120 and the base 110, and lubricants may optionally be utilized. Further, materials may be selected that have relatively low coefficients of friction. In FIG. 3, the primary hub 120 is shown resting atop an upper lip 113a of a segment 113 of the terminal portion 112. If such an arrangement is incorporated (or a similar arrangement, such as resting atop a ledge formed by a collar), thrust bearings may be used to minimize friction between the primary hub 120 and the lip 113a (or the collar ledge). In some embodiments, the primary hub 120 may be outwardly adjacent a collar extending from a cylindrical portion of the stationary base 110 that has a generally constant diameter, such that bearings are present between the primary hub 120 and the collar instead of directly between the primary hub 120 and a non-expanded portion of the stationary base 110.

Those skilled in the art will appreciate that friction between the primary hub 120 and the base 110 may be reduced/minimized in various ways, and may very well make further advancements in attaching the primary hub 120 to the stationary base 110 beyond those methods currently preferred and disclosed herein. Functionally, it would be desirable to eliminate friction between the rotating hub 120 and the base 110 entirely. In practice, however, cost and technology limitations may make such elimination impossible or impracticable.

The primary support arms (or “spokes”) 130 (FIGS. 1 through 7) extend radially from the primary hub 120. A proximal end 132a (FIGS. 2 and 3) of each primary support arm 130 is fixed to the primary hub 120 (e.g., by bolts 133 as shown in FIG. 2, welding, and/or any other appropriate fastener) or formed uniformly with the primary hub 120, and a distal end 132b (FIG. 2) of each primary support arm 130 extends outwardly in a generally rigid manner to be operatively coupled to respective capturing elements 170, as discussed further below.

The self-positioning arm 140 is generally rigid and has proximal and distal ends 142a, 142b, with a hole 143 extending through the proximal end 142a. Like the primary hub 120, the self-positioning arm 140 is mounted to the stationary base 110 in a manner that allows the self-positioning arm 140 to rotate about a generally vertical axis (e.g., the same axis of rotation as that of the primary hub 120), preferably with little resistance from interaction with the base 110. Bearings 144 for reducing friction between the self-positioning arm 140 and the base 110 passing through the hole 143 are shown in FIG. 3, and a cap 115 is shown to prevent the self-positioning arm 140 and the base 110 from separating. While the self-positioning arm 140 and the primary hub 120 are both rotatably mounted to the stationary base 110, each is mounted independently of the other such that the two elements 120, 140 may rotate about the base 110 at different times, directions, and speeds.

The secondary hub 150 is operatively mounted to the distal end 142b of the self-positioning arm 140 and includes structure (e.g., mounting rods 156) to which the secondary arms 160 are mounted. A spacer 152 is shown (FIG. 3) raising the mounting structure for the secondary arms 160 to ensure that the secondary arms 160 do not collide with the stationary base 110 or cap 115 when in use. In the turbine 100, the distal end 142b of the self-positioning arm 140 includes a plurality of holes 145, and a bolt 153 passes through the secondary hub 150, the spacer 152, and one of the holes 145 to secure the secondary hub 150 and the spacer 152 to the self-positioning arm 140. The secondary hub 150 may be considered as two distinct portions: a first portion for attaching to the self-positioning arm 140 (e.g., the spacer 152, fastening structure such as the bolt 153, and an interior raceway 154), and a second portion for rotating relative to the first portion (e.g., an exterior raceway 155 and the mounting rods 156). In different embodiments, the first and second portions may include different combinations of elements. For example, the first portion may alternately include an external raceway coupled to the self-positioning arm 140, and the second portion may alternately include an internal raceway, spacer, and mounting rods. It may be very desirable for the axis of rotation for the secondary hub 150 to be generally parallel to the axis of rotation for the primary hub 120.

Bearings 157 are shown in FIG. 3 between the raceways 154, 155 to reduce friction. Those skilled in the art will appreciate that excessive friction relating to rotation of the secondary hub 150 is undesirable, and additional friction-reducing technology (e.g., lubricants, etc.) may also, or alternately, be utilized.

Attention is now directed to the secondary (or “adjustment”) arms 160, each of which may be generally identical to one another. Each adjustment arm 160 is generally rigid and has proximal and distal ends 162a, 162b. The proximal and distal ends 162a, 162b are configured to be pivotally coupled to the secondary hub 150 (e.g., to the mounting rods 156) and a capturing element 170, respectively. In the turbine 100, the adjustment arm proximal ends 162a and distal ends 162b each include an eye 163 for providing this pivotal interaction. Other pivotal coupling structure could of course be utilized, however, on either or both ends 162a, 162b, provided that complementary structure exists on the secondary hub 150 or the capturing elements 170. And, as with other rotatable connections in the turbine 100, steps may be undertaken to maintain friction at acceptable levels, such as selecting materials with low coefficients of friction, using bearings, using lubricants, et cetera. With the proximal ends 162a of the secondary arms 160 rotatably coupled to the secondary hub 150, such as by passing the mounting rods 156 through respective proximal end eyes 163, the secondary arms 160 may extend outwardly from the secondary hub 150. It may be desirable for each of the secondary arms 160 to generally lie in a common plane when extended.

As shown in FIGS. 1 and 2 and noted above, each capturing element 170 (which may be generally identical to each other capturing element 170) is pivotally coupled to the distal end 132b of a respective primary support arm 130 and a distal end 162b of a respective adjustment arm 160. Those skilled in the art will appreciate that various pivotal couplings may be used. If the adjustment arm distal ends 162b each include an eye 163 as discussed above, each capturing element 170 may include a complementary mounting rod 172 (FIG. 1) that passes through an eye 163 in a manner that allows rotation. As shown in FIG. 1, each primary support arm distal end 132b may include a collar 138, and a mounting rod (e.g., part of a frame 174 that defines the perimeter of the respective capturing element 170) may pass through each respective collar 138 in a manner that allows rotation. As with other rotatable connections in the turbine 100, steps may be undertaken to maintain friction at acceptable levels, such as selecting materials with low coefficients of friction, using bearings, using lubricants, et cetera.

The locations of the primary and secondary support arm distal ends 132b, 162b relative to the capturing elements 170 shown in the accompanying figures are such that capturing elements 170 are intended to rotate counter-clockwise about the primary hub 120. If desired, a clockwise setup may be achieved by altering the locations of the primary and secondary support arm distal ends 132b, 162b relative to the capturing elements 170, as those skilled in the art will appreciate.

The capturing elements 170 may have various shapes and may be constructed of various materials, and those skilled in the art will be able to provide multiple acceptable structures. The capturing elements 170 shown in FIGS. 1 and 2 are generally arcuate and include material 175 removably, though tautly, fastened to the frame 174 (e.g., by clips 176). Without the material 175 installed, the capturing elements 170 may be ineffective at capturing wind. The material 175 may be, for example, fabric, fiberglass, synthetic resin, and/or composites, and the material 175 may include indicia intended to be viewed while the capturing elements 170 are rotating. It may be desirable for the capturing elements 170 (e.g., the material 175) to fail upon receiving wind of a velocity that is predetermined to be excessive, as failure of the capturing elements 170 may provide a safeguard against the turbine 100 operating in excessive wind speeds. Replacing the material 175 may be relatively inexpensive, and may even be undertaken periodically to provide alternate indicia.

Turning to FIGS. 1 and 3, a drive member 180 may be carried by the primary hub 120 for rotation about the stationary base 110. The drive member 180, in turn, may be operatively coupled (e.g., by gearing 182) to drive an energy generator 185, or a plurality of generators 185, for producing power. The energy generator 185 may be an electrical energy generator for generating either alternating current or direct current, and may be connected to a controller or other device for delivering power thereto and for receiving control signals therefrom.

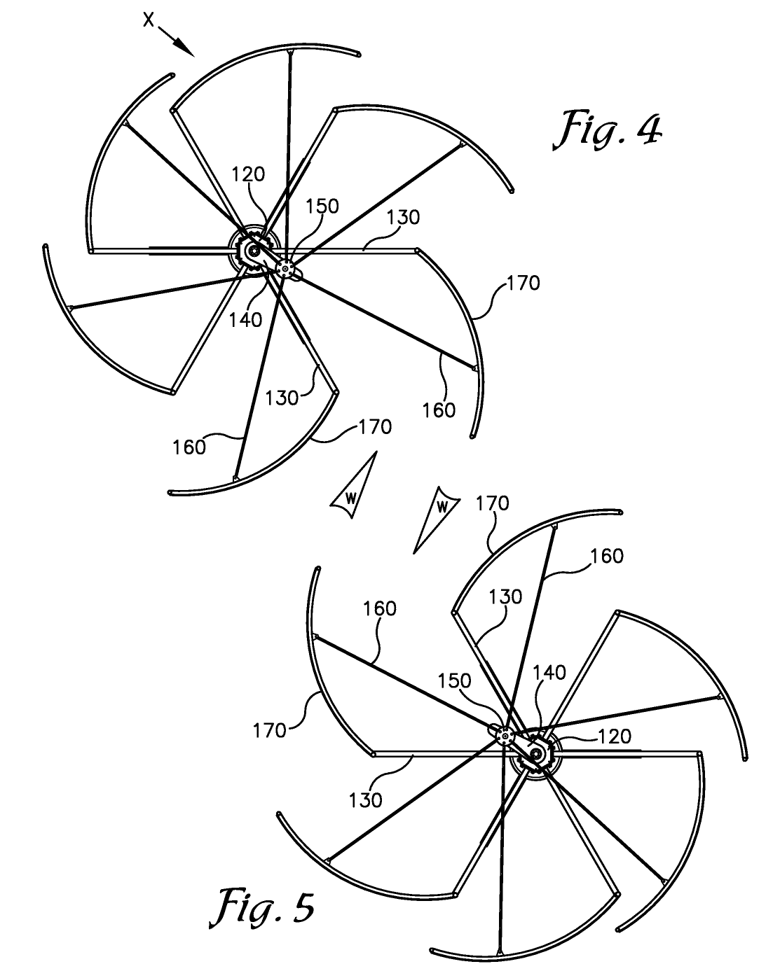

In use, the turbine 100 self directs without the use of a wind vane or electrical sensors in communication with actuating equipment (e.g., a motor, gearing, et cetera), and rotation of the primary hub 120 causes the drive member 180 to drive the energy generator 185 and produce power. The self directing is illustrated in FIGS. 4 through 7, where wind direction W varies. The forces of the wind on the various capturing elements 170 in turn cause the adjustment arms 160 to impart forces on the self-positioning arm 140 via the secondary hub 150. As a result of the forces from the adjustment arms 160, the self-positioning arm 140 rotates about the base 110 until those forces are equalized; at the equalized (or “neutral”) point (shown to vary in FIGS. 4 through 7, due to the different wind directions W), the self-positioning arm 140 stops rotating about the base 110 and remains generally stationary until the wind direction W changes. The purpose of self directing is to allow the capturing elements 170 to collectively capture a maximum (or acceptably large) amount of energy. The importance of redirecting the capturing elements 170 can be seen by viewing FIG. 4; if the wind direction were instead from direction X instead of W, and if the turbine could not redirect, comparatively much less wind energy would be captured (e.g., because the wind would not interact with as much internal surface area of the capturing elements 170).

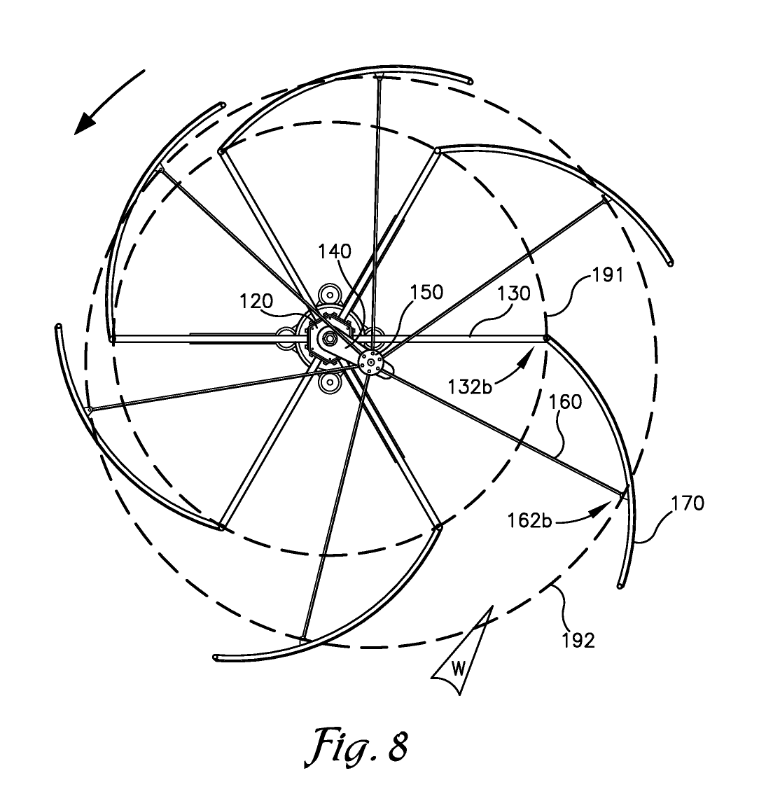

In operation, regardless of the wind direction W, the support arm distal ends 132b have a path of travel that circumscribes a first circle 191 (FIG. 8) having a constant location and diameter. The adjustment arm distal ends 162b similarly have another path of travel that circumscribes a second circle 192 (FIG. 8) having a generally constant diameter, regardless of the wind direction W. While the location of the second circle 192 moves based on the wind direction W and the self adjustment described above, center points for the first and second circles 191, 192 are always offset from one another.

As described above, the adjustment arms 160 operate to adjust the location of the self-positioning arm 140, but the second circle 192 maintains a generally constant diameter. But in other embodiments, the adjustment arms 160 may be modifiable (e.g., by telescoping, bending, moving the points of contact between the adjustment arms 160 and the capturing elements 170, etc.) to vary the size of the second circle 192.

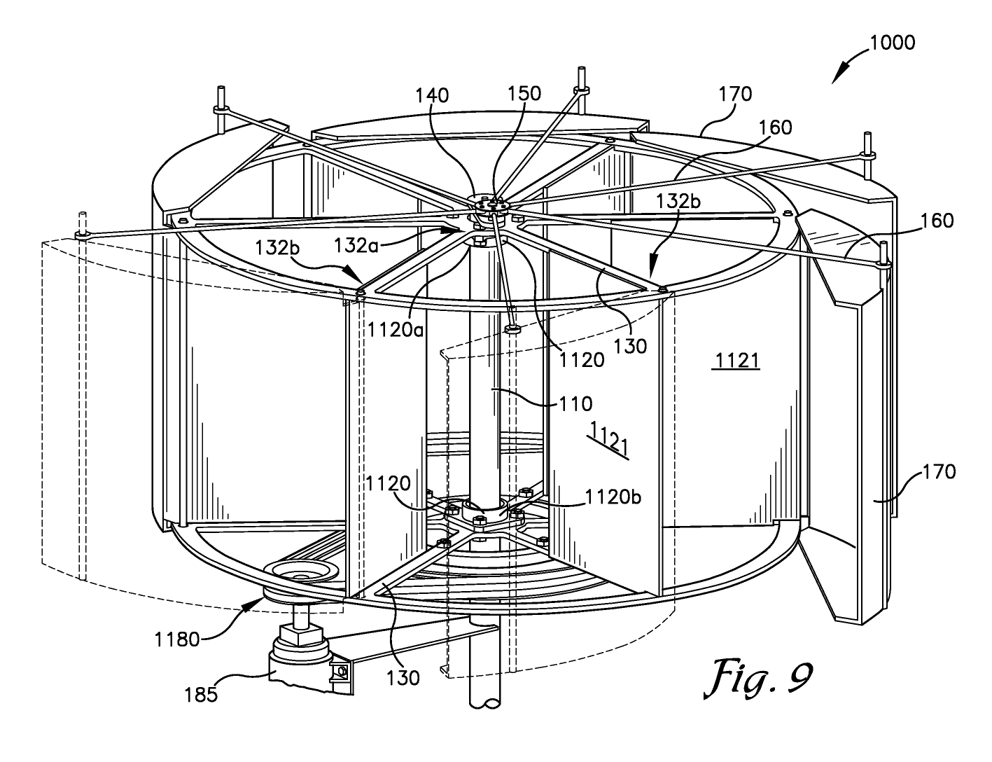

FIG. 9 shows another wind turbine embodiment 1000 that is substantially similar to the embodiment 100, except as specifically noted and/or shown, or as would be inherent. Further, those skilled in the art will appreciate that the embodiment 100 (and thus the embodiment 1000) may be modified in various ways. For uniformity and brevity, corresponding reference numbers may be used to indicate corresponding parts, though with any noted deviations.

A primary distinction between the turbine 1000 and the turbine 100 is that the turbine 1000 includes two primary hubs 1120 (upper hub 1120a and lower hub 1120b), replacing the primary hub 120. As with the primary hub 120, the hubs 1120a, 1120b are rotatable about the stationary base 110 independent of the self-positioning arm 140, the secondary hub 150, and the secondary arms 160. Walls 1121, columns, or other structure may fasten the hubs 1120a, 1120b together such that both hubs 1120a, 1120b experience the same rotational movement. The walls 1121 may additionally function to capture wind energy when exposed.

Other differences in the turbine 1000 are found in the primary support arms 130 and the drive member 180. In the turbine 1000, the primary support arms 130 of each primary hub 1120 are coupled together (e.g., at distal ends 132b and proximal ends 132a), which may provide a more rigid configuration. Though not shown, it is further possible for the primary support arms 130 to be configured as a sheet, with or without explicit delineations between the support arms 130. The drive member 180 has been replaced with a pulley system 1180 that drives the energy generator 185.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention. It will be understood that certain features and subcombinations are of utility and may be employed without reference to other features and subcombinations and are contemplated within the scope of the claims.

We claim:

1. A self-directing vertical axis turbine, comprising:
a base;
a first hub rotatably coupled to the base for free rotation about a first generally vertical axis;
a plurality of first support arms extending radially from the first hub, each first support arm having a distal end;
a positioning arm rotatably coupled to the base for free rotation about the first generally vertical axis, attachment of the positioning arm to the base being independent of the attachment of the first hub to the base whereby the positioning arm and the first hub may rotate about the base at different times and speeds;
a second hub rotatably coupled to a distal end of the positioning arm for rotation about a second generally vertical axis;
a plurality of second support arms extending outwardly from the second hub, each second support arm having a distal end; and
a plurality of capturing elements, each capturing element being rotatably coupled to a respective first arm distal end and a respective second arm distal end;
wherein the first support arm distal ends have a common path of travel about the base that circumscribes a first circle having a constant diameter and a constant location relative to the base;
wherein the second support arm distal ends have a common path of travel about the second hub that circumscribes a second circle, the location of the second circle relative to the base moving with rotation of the positioning arm relative to the base, the first and second circles having center points that are offset from one another; and
wherein the positioning arm rotates about the first axis based upon forces imparted by a fluid upon the capturing elements and transferred to the positioning arm by the second support arms and the second hub.

2. The self-directing vertical axis turbine of claim 1, wherein the second circle has a generally constant diameter when the positioning arm is not rotating relative to the base.

3. The self-directing vertical axis turbine of claim 1, further comprising bearings between the first hub and the base, and bearings between the positioning arm and the base.

4. The self-directing vertical axis turbine of claim 3, wherein the base is a pole that extends generally vertically.

5. The self-directing vertical axis turbine of claim 4, wherein a terminal portion of the pole is segmented into portions of differing diameters.

6. The self-directing vertical axis turbine of claim 5, wherein the second hub has a first portion for attaching to the positioning arm and a second portion for rotating relative to the first portion.

7. The self-directing vertical axis turbine of claim 6, wherein the second circle has a generally constant diameter when the positioning arm is not rotating relative to the base.

8. The self-directing vertical axis turbine of claim 7, wherein the first support arms are coupled together.

9. The self-directing vertical axis turbine of claim 7, wherein the first support arms are configured as a sheet without explicit delineations between the first support arms.

10. The self-directing vertical axis turbine of claim 7, wherein the first support arms are configured as a sheet with explicit delineations between the first support arms.

11. A self-directing vertical axis turbine, comprising:
a base;
a primary hub rotatably coupled to the base for rotation about a first axis;
a plurality of primary support arms extending radially from the primary hub, each primary support arm having a distal end;
a positioning arm rotatably coupled to the base for free rotation about the first axis, attachment of the positioning arm to the base being independent of the attachment of the primary hub to the base whereby the positioning arm and the primary hub may rotate about the base at different times and speeds;
a secondary hub rotatably coupled to the positioning arm for rotation about a second axis that is spaced apart from and generally parallel to the first axis, the second axis being fixed relative to the positioning arm and being movable relative to the first axis;
a plurality of secondary arms extending outwardly from the second hub, each secondary arm having a distal end; and
a plurality of capturing elements, each capturing element being rotatably coupled to a respective primary support arm distal end at a first point and a respective secondary arm distal end at a second point;
wherein the first points have a common path of travel about the base that circumscribes a first circle having a constant diameter and a constant location relative to the base;
wherein the second points have a common path of travel about the second hub that circumscribes a second circle, the location of the second circle relative to the base moving with rotation of the positioning arm relative to the base, the first and second circles having center points that are offset from one another; and
wherein the positioning arm rotates about the first axis based upon forces imparted by a fluid upon the capturing elements and transferred to the positioning arm by the secondary arms and the secondary hub.

12. The self-directing vertical axis turbine of claim 11, wherein the secondary hub has a first portion for attaching to the positioning arm and a second portion for rotating relative to the first portion.

13. The self-directing vertical axis turbine of claim 12, further comprising bearings between the primary hub and the base, and bearings between the positioning arm and the base.

14. The self-directing vertical axis turbine of claim 13, wherein the second circle has a generally constant diameter when the positioning arm is not rotating relative to the base.

15. The self-directing vertical axis turbine of claim 14, wherein a terminal portion of the base is segmented into portions of differing diameters.

16. The self-directing vertical axis turbine of claim 15, wherein the plurality of capturing elements is six capturing elements.

17. The self-directing vertical axis turbine of claim 16, wherein each capturing element includes material removably and tautly fastened to a frame.

18. The self-directing vertical axis turbine of claim 11, wherein each capturing element includes material removably and tautly fastened to a frame.

19. The self-directing vertical axis turbine of claim 18, wherein:
the material has a failure strength selected to prevent the capturing elements from fully operating upon receiving a fluid having a speed that is predetermined to be excessive; and
the material includes indicia intended to be viewed while the capturing elements are rotating.
